(19) United States
(12) Patent Application Publication
(10) Pub. No.: US 2010/0309307 A1
(43) Pub. Date: Dec. 9, 2010

(54) Automatic stent inspection system

(76) Inventor: Ju Jin, Austin, TX (US)

Correspondence Address: Ju Jin, 10619 Senna Hills Dr., Austin, TX, 78733, US

(21) Appl. No.: 12/455,821

(22) Filed: Jun. 8, 2009

(51) Int. Cl. H04N 7/18; G06K 9/00

(52) U.S. Cl. 348/86; 382/141; 348/92; 348/E07.085

(57) ABSTRACT

A fully automated inspection system provides for inspection, measurement and characterization of a wire mesh tube, particularly a stent. The system uses an optical imaging subsystem to capture high resolution color images of both exterior and interior surfaces of a stent. Defects are defected by processing the captured images using proprietary algorithms. Geometric dimensional features of a stent are measured by processing the stitched 2-D map of the stent. In addition, a surface-scanning profiling subsystem is used to measure the surface roughness of drug films or metallic surfaces. It also measures the 3-D profile of a stent strut.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### FIELD OF THE INVENTION

The present disclosure relates to inspection, measurement and characterization of a wire mesh tube, particularly relates to inspection, measurement and characterization of a stent.

### BACKGROUND OF THE INVENTION

The statements in this section merely provide background information related to the present disclosure and may not constitute prior art.

Percutaneous Coronary Intervention (PCI), commonly known as coronary angioplasty, is a medical procedure in which a balloon is used to open a blockage in a coronary artery narrowed by atherosclerosis. This procedure improves blood flow to the heart.

Atherosclerosis is a condition in which a material called plaque builds up on the inner walls of the arteries. This can happen in any artery, including the coronary arteries. The coronary arteries carry oxygen-rich blood to your heart.

A stent, a small wire mesh tube, is usually placed in the newly widened part of the artery. The stent holds up the artery and lowers the risk of the artery re-narrowing. Stents are made of metal mesh and look like small springs. There are two basic types: one is drug eluting stent (DES), the other is bare metal stent (BMS).

Since stents are implanted into coronary arteries and other flood flow paths, a failure in function of a stent could lead to death or serious injuries of patients. Therefore, stent makers typically implement 100% inspection before shipping to hospitals.

Stent inspection includes dimensional inspection and defect inspection. Dimensional inspection is implemented to ensure critical dimensional features of a stent are within tolerances. These dimensional features include: 1) inner diameter; 2) outer diameter; 3) surface roughness; 4) strut profile; 5) strut width; 6) wall thickness; 7) strut length; and 8) other geometrical features such as corner radius and cell size.

Defect inspection is implemented to detect: 1) sharp edge; 2) micro cracks; 3) bad laser cut; 4) uneven drug coating uniformity; 5) drug film voids; 6) film flaking; 7) film bridge, 8) scratches; 9) pits; 10) metal residues; and 11) other life threatening tiny defects.

Unfortunately, at present time, existing automatic or semi-automatic stent inspection tools can measure some of the dimensional features and perform some limited visual defect inspection. They cannot perform all the inspection tasks mentioned above in an automatic manner.

As a result, stent inspection has been heavily relying on human operators. Typically, a stent is rotated under an optical microscope or a scanning electron microscope while the operator is looking for defects cell by cell. The manual stent inspection process is labor intensive and time consuming, also open to human error. On average, it takes four hours for a well-trained operator to complete the inspection of a single stent.

As stents continue to shrink its size and increase its structural complexity, the inspection becomes more and more challenging.

Each year millions of life-saving stents are implanted in patients worldwide. To ensure defect-free stents are delivered to patients, cost effective and reliable automatic inspection systems which can meet the requirements mentioned above are highly demanded by stent makers.

### BRIEF SUMMARY OF THE INVENTION

Further areas of applicability will become apparent from the description provided herein. It should be understood that the description and specific examples are intended for purposes of illustration only and are not intended to limit the scope of the present disclosure.

The object of the present invention is to provide a fully automated stent inspection system. It comprises three illuminators: an external illuminator, a co-axial illuminator and a telecentric illuminator. The external and co-axial illuminators provide uniformly diffused illumination across both the interior and exterior surfaces of a stent, while the telecentric illuminator provides telecentric backlight. The fully automated stent inspection system also comprises an optical imaging subsystem to image a portion of stent, a surface-scanning profiling subsystem to characterize the surface condition and measure the 3D profile of a stent wire, a mandrel to hold the stent, a vertical stage to adjust the working distance between the optical imaging subsystem and the stent, a linear stage to move a stent from its load position to the inspection position, a rotary stage to rotate the stent in a step-and-stop fashion, and a control console.

Individual images obtained from the high resolution color area scan camera of the optical imaging subsystem are stitched together to form a complete 2-D stent map. Defects as well as strut's geometric dimensions are detected and measured from the color images and the 2-D map using proprietary image processing and pattern recognition algorithms.

The lateral and height information from the surface-scanning profiling subsystem is sent to the control console. Surface roughness of drug films or bare metals, strut profile as well as thickness is calculated using proprietary signal processing algorithms.

The control console provides tool control functions as well as at least the following capabilities: 1) automatic defect detection and classification with enough sensitivity and speed; 2) automatic measurement of geometric features of a stent; 3) automatic measurement of surface roughness as well as strut profile; and 4) automatic report of inspection and measurement results.

### BRIEF DESCRIPTION OF THE SEVERAL VIEWS OF THE DRAWINGS

The drawings described herein are for illustration purposes only and are not intended to limit the scope of the present disclosure in any way.

FIG. 1 shows a schematic front view of an automatic stent inspection system of the present disclosure.

FIG. 2 shows a schematic view of the telecentric illuminator shown in FIG. 1.

FIG. 3 shows a schematic view of the external illuminator shown in FIG. 1.

FIG. 4 shows a schematic view of the co-axial illuminator shown in FIG. 1.

FIG. 5 shows a schematic view of the optical imaging subsystem shown in FIG. 1.

FIG. 6 illustrates the alignment of the principal axis of the optical imaging subsystem to the vertical axis through the centroid of a stent.

FIG. 7 illustrates the operational principle of the surface-scanning profiling subsystem shown in FIG. 1.

FIG. 8 shows an example of the output of the surface-scanning profiling subsystem shown in FIG. 7.

FIG. 9 illustrates the step-and-stop motion profile of the rotary stage shown in FIG. 1.

FIGS. 10A-10C illustrate the inspection segments and the step-and-stop motion profile of the linear stage shown in FIG. 1.

FIGS. 11A-D show the operational steps of one of the embodiments of the system of the present disclosure.

FIG. 12 shows the major software modules inside the control console shown in FIG. 1.

FIG. 13 illustrates another embodiment of the system of the present disclosure.

FIGS. 14A-D show some defect types of drug eluting stents.

### DETAILED DESCRIPTION OF THE IVENTION

The following description is merely exemplary in nature and is not intended to limit the present disclosure, application, or uses. It should be understood that throughout the drawings, corresponding reference numerals indicate like or corresponding parts and features.

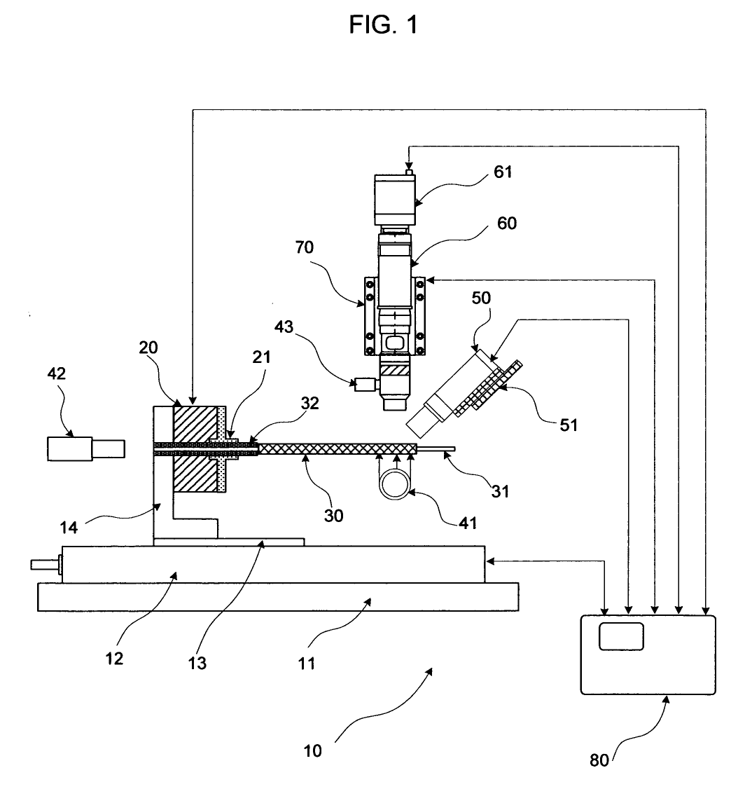

Referring to FIG. 1, an automatic stent inspection system 10 consists of a base 11, a linear stage 12, a rotary stage 20, a collet chuck 21, a mandrel 31, a mandrel holder 32, a telecentric illuminator 41, an external illuminator 42, a co-axial illuminator 43, a surface-scanning profiling subsystem 50, a positioning assembly 51, an optical imaging subsystem 60, a color area scan camera 61, a vertical stage 70 and a control console 80.

Referring to FIG. 1, a stent 30 under inspection is mounted on a mandrel 31. The mandrel 31 can be a tube or a rod made of optical transparent material such as quartz, sapphire or other optical glass. Its surface can be polished or unpolished. The outer diameter of the mandrel 31 is slightly bigger than the inner diameter of the stent 30, preventing the stent 30 from slipping on the mandrel 31 when the mandrel 31 rotates.

Referring to FIG. 1, the mandrel 31 is mounted on a mandrel holder 32. The mandrel holder 32 is a tube-like object made of rigid material such as peek. Its inner diameter varies with the outer diameter of the mandrel 31.

Referring to FIG. 1, the mandrel holder 32 is mounted on a collet chuck 21, and the collet chuck 21 is mounted on a rotary stage 20.

Referring to FIG. 1, the rotary stage 20, the collet chuck 21, the mandrel holder 32, and the mandrel 31 are precisely assembled together to keep the radial run-out of the mandrel 31 within the predefined range, for example, less than 25 microns.

Referring to FIG. 1, the rotary stage 20 is mounted on a linear stage 12 through a bracket 14. In more detail, the rotary stage 20 in mounted on a linear stage carrier 13 through the bracket 14. When the linear stage carrier 13 moves back and forth in the horizontal direction, the rotary stage 20, the collet chuck 21, the mandrel holder 32, the mandrel 31 and the stent 30 all moves together with the linear stage carrier 13.

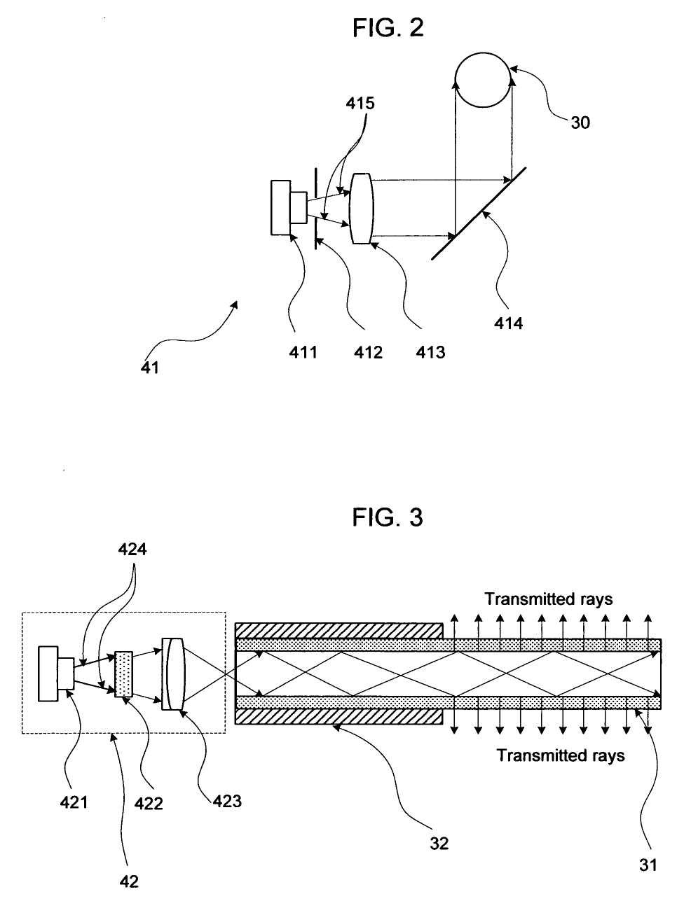

Referring to FIGS. 1 and 2, a telecentric illuminator 41 is placed under the stent 30. The telecentric illuminator 41 consists of a light source 411, a spatial filter 412, a telecentric lens assembly 413 and a fold mirror 414. A light ray 415 from the light source 411 first travels through t the spatial filter 412, collimated by the telecentric lens assembly 413, then reflected by the fold mirror 414, finally reaches the stent 30. In such an arrangement, the telecentric illuminator 41 provides parallel illumination rays to the optical imaging subsystem 60, enabling precise and accurate dimensional measurement of the stent 30.

Referring to FIGS. 1 and 3, an external illuminator 42 is mounted on the bracket 14. The external illuminator 42 consists of a light source 421, a diffuser 422 and a focus lens 423. A light ray 424 from the light source 421 is first diffused by the diffuser 422. Then its beam size is adjusted by the focus lens 423 to match the inner diameter of the mandrel 31. After entering into the mandrel 31, the light ray 424 travels inside the mandrel 31, some of the light ray transmits through the mandrel wall, providing uniform illumination across the interior surface of the stent 30 which are mounted on the mandrel 31.

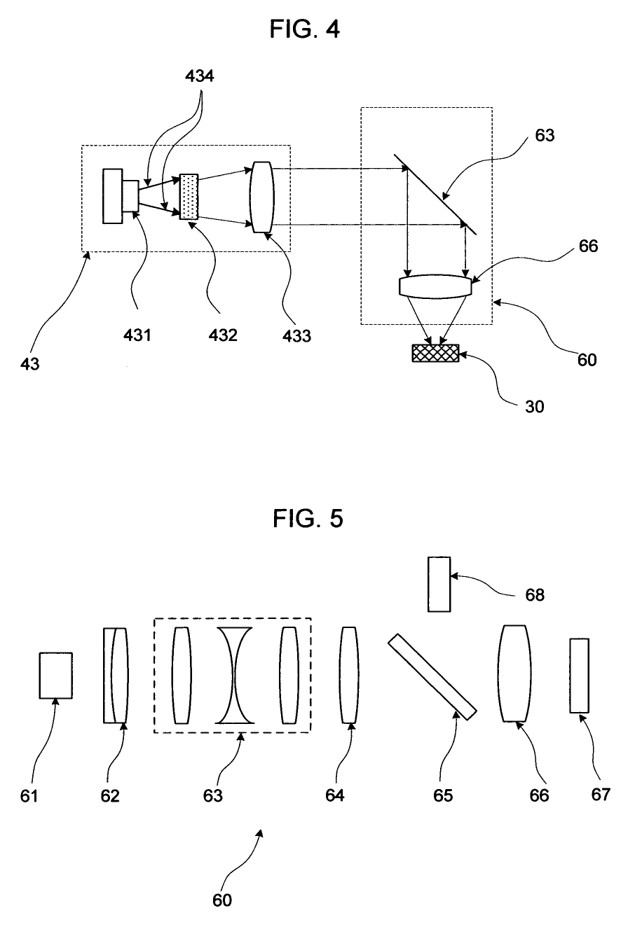

Referring to FIGS. 1 and 4, a co-axial illuminator 43 is attached to the optical imaging subsystem 60. The co-axial illuminator 43 consists of a light source 431, a diffuser 432 and a collimate lens 433. A light ray 434 from the light source 431 is first diffused by the diffuser 432, then collimated by the collimate lens 433. After entering into the optical imaging subsystem 60, the light ray 434 is reflected by a half-mirror 65, focused by an objective lens 66, passes through a filter 67, and finally reaches to the stent 30. In such an arrangement, the portion of the exterior surface of the stent 30 under inspection is uniformly illuminated.

Referring to FIGS. 1 and 5, an optical imaging subsystem 60 consists of an co-axial illumination input port 68, a filter 67, an objective lens 66, a half mirror 65, a focusing lens 64, a zoom lens 63, a magnifier lens 62 and a high resolution area scan color camera 61. The focusing lens 64 presets the best focus position before starting automatic inspection and during the manual review process. The filter 67 can be a polarizer, or an optical filter which allows the passage of predetermined wavelengths.

The zoom lens 63 is configured based on the strut size of the stents to be inspected. In more detail, the zoom lens 63 can be configured in the low magnification range for stents with large struts and higher magnification range for stents with small struts.

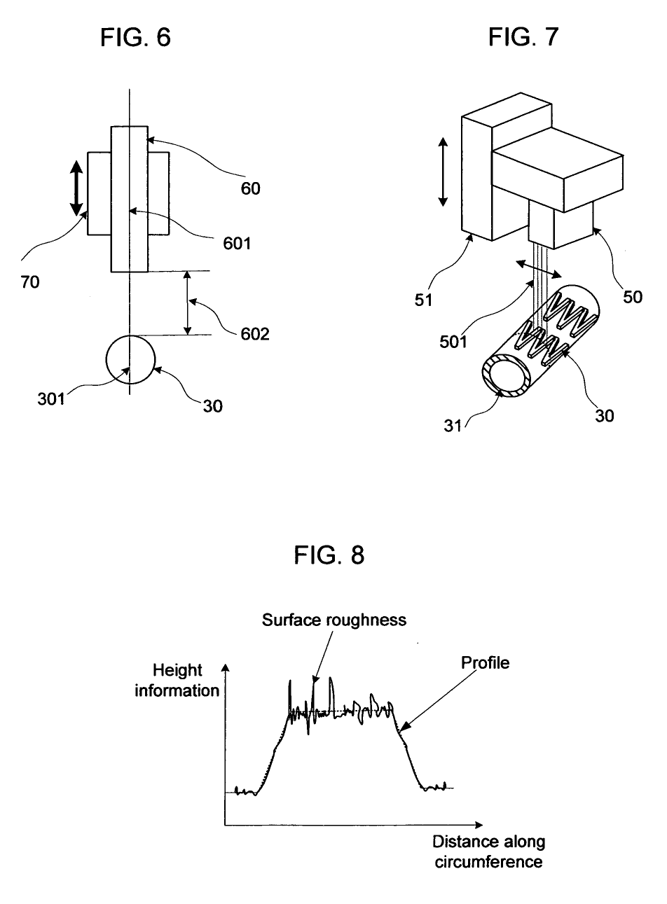

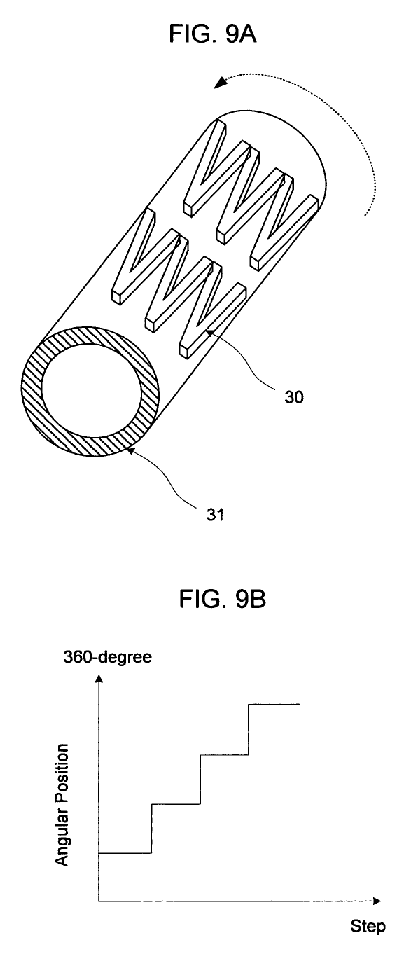

Referring to FIG. 6, the optical imaging subsystem 60 is mounted on a vertical stage 70. To improve image quality, the optical imaging subsystem 60 is orientated in such a way that its principal axis 601 is perfectly aligned to coincide with the vertical axis through the centroid 301 of the stent 30. The vertical stage 70 moves the optical imaging subsystem 60 upward and downward automatically or in a controlled manner, adjusting the distance 602 between the optical imaging subsystem 60 and the surface (either exterior or interior) of the stent 30, ensuring that the inspected portion of the stent is always in the best focus position during the image acquisition period.

Referring to FIGS. 1, 7 and 8, a surface-scanning profiling subsystem 50 utilizes a laser beam 501 to scan the surface of the stent 30 along the circumference direction. It measures the distance between the surface-scanning profiling subsystem 50 and the stent 30 at nanometer resolution. Its output is illustrated in FIG. 8. The surface roughness and the 3-D profile of the stent 30 are then calculated from the output using proprietary algorithms. The surface-scanning profiling subsystem 50 is mounted on a positioning assembly 51. The main function of the positioning assembly 51 is to preset the distance between the surface-scanning profiling subsystem 50 and the stent 30 to the predetermined value. This procedure is necessary for inspection stents with different diameters or the same stent with different diameters in different sections.

Referring to FIGS. 1 9A and 9B, the rotary stage 20 rotates the mandrel 31 and thus the stent 30 in a step-and-stop manner. In more detail, the rotary stage 20 moves forward one step (routine-defined angle) and stops completely. The optical imaging subsystem 60 moves to the best focus position, then the camera 61 takes an image of the portion of the stent within the field of view of the optical imaging system 60. After completion, the rotary stage 20 rotates one more step, settling down completely, the optical imaging subsystem 60 moves to the best focus position, then the camera 61 takes the second image of the stent. The above steps are repeated until the whole circumference of a segment of the stent 30 is imaged.

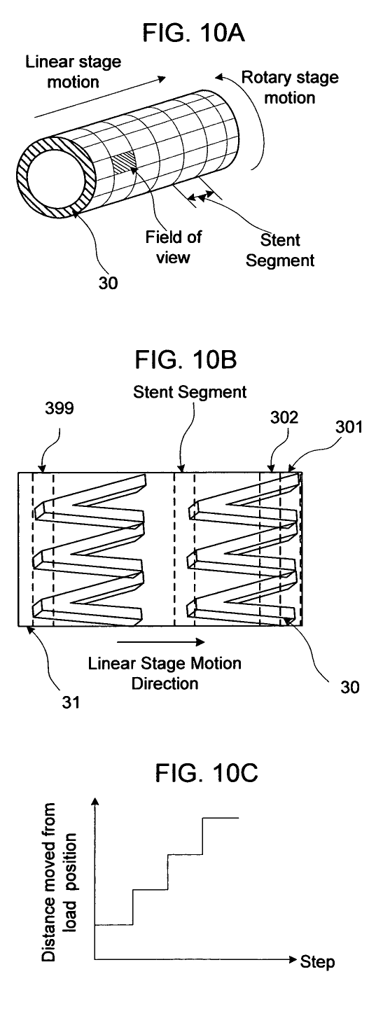

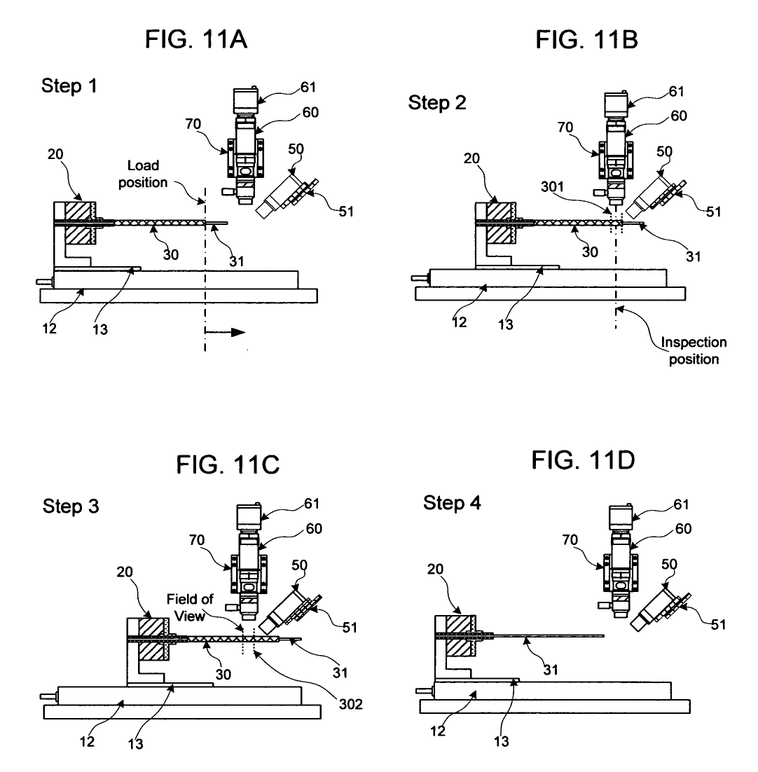

Referring to FIGS. 10A-C and 11A-D, the linear stage 12 performs two main functions. First it moves the stent 30 from its load position to the inspection position, as shown in FIG. 11B. Secondly, it successively moves the different segments of the stent 30 into the field of view of the optical imaging subsystem 60 in a step and stop fashion, as shown in FIGS. 10A-C.

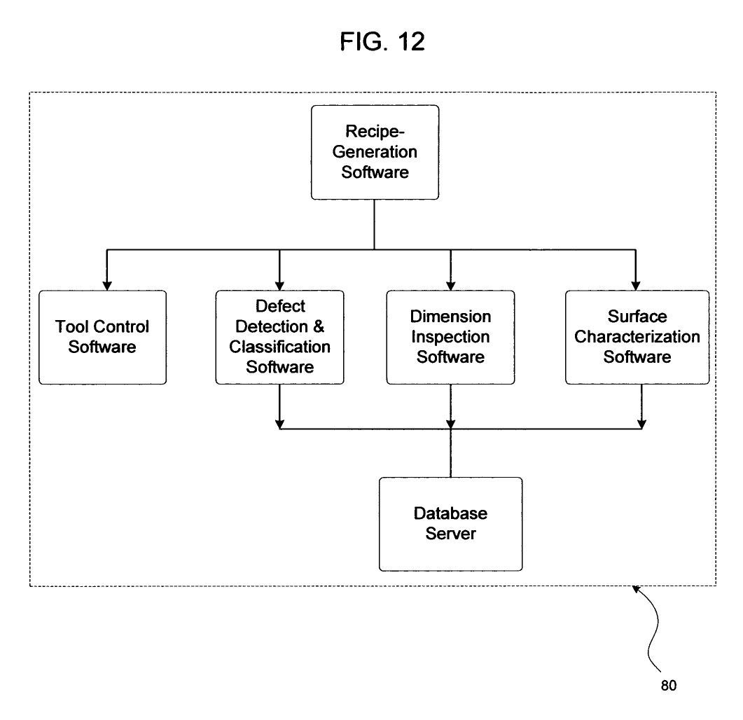

Referring to FIGS. 1 and 12, the control console 80 controls the system 10 via the tool control software. In this regard, the control console controls the motion of the linear stage 12, the rotary stage 20, and the vertical stage 70. It also initializes the image and data acquisition timing, as well as performs other essential functions to complete the automatic inspection of a stent using user-predefined recipes.

The control console 80 also displays the acquired images from the color area scan camera 61, running the defect detection software, plotting the acquired data from the surface-scanning profiling subsystem 50, calculating strut's profile and surface roughness, reporting the results files to user's quality control system.

FIGS. 11A-D illustrate the operation of one embodiment of the automatic stent inspection system 10 of the present disclosure. In Step 1, referring to FIG. 11A, a stent 30 is mounted onto a mandrel 31 in the presetting mounting position by an operator. After the operator completely moves away from the operating area of the system 10, the control console 80 powers on the linear stage 12, the rotary stage 20 and the vertical stage 70, initializing and moving them to the respective home positions. Following that, the linear stage 12 moves the first segment 301 of the stent 30 to the inspection position, and stops completely.

In Step 2, referring to FIG. 11B, the control console 80 turns on one of or any combination of the illuminators 41, 42 and 43 based on operator's predetermined parameters or recipes. The vertical stage 70 automatically detects the distance between the stent and the objective lens, bringing the optical imaging subsystem 60 to the best focus position. After the vertical stage 70 completely settling down in the best focus position, the camera 61 starts to take the image of the portion of the first segment 301 within the field of view of the optical imaging system 60. At the same time the surface-scanning profiling subsystem 50 measures the profile and surface roughness of the same portion. After completion, the rotary stage 20 rotates one more step with the step size same as the field of view of the optical imaging system 60. Once the rotary stage 20 settles down completely, the optical imaging subsystem 60 is brought to the best focus position by the vertical stage 70 again, the camera 61 takes the second image of the segment 301, and the surface-scanning profiling subsystem 50 measures the profile and surface roughness of the second portion of the segment 301. The above steps are repeated until the whole circumference of the segment 301 is imaged, and the profile and surface roughness are measured. At the end of Step 2, the rotary stage 20 rotates to its home position.

In Step 3, referring to FIG. 11C, the linear stage 12 moves forward one more step and sends the second segment 302 of the stent 30 to the inspection position. The step size of the linear stage 12 is defined in operator's recipes and is determined by the field of the view of the optical imaging subsystem 60, in return it is determined by the magnification of the zoom lens 63 in FIG. 5. Once the linear stage 12 settled down completely, the vertical stage 70 automatically adjust the distance between the stent and the optical imaging subsystem 60, bringing the optical imaging subsystem 60 to the best focus position, then camera 61 takes an image of the portion of the second segment 302 within the field of view of the optical imaging system 60. At the same time the surface-scanning profiling subsystem 50 measures the profile and surface roughness of the same portion. After completion, the rotary stage 20 rotates one more step, settling down completely, the optical imaging subsystem 60 moves to the best focus position, then the camera 61 takes the second image of the segment 302, the surface-scanning profiling subsystem 50 measures the profile and surface roughness of the same portion. The above processes are repeated until the whole circumference of the second segment 302 is imaged, profile and the surface roughness are measured.

The Step 3 is repeated until the last segment of the stent 30 is completely imaged and its profile as well as surface roughness is completed measured.

In Step 4, referring to FIG. 11D, after the whole stent 30 has been imaged and measured, the control console 80 moves the linear stage 12 back to its home position and thus the stent is brought back to its load position. The control console powers down the linear stage 12, the rotary stage 20 and the vertical stage 70, turning off the illuminators. The operator enters into the operating area, offloading the stent 30 from the mandrel 31.

During the same time period (Step 4), the control console 80 shown in FIG. 12 stitches the individual images obtained from the area-scan color camera 61 together to form a complete 2-D stent map. The defect detection and classification software installed in the control console 80 processes the 2-D stent map as well as the original raw images, detects the defects of interest, classifies them into different category and outputs to the results files.

In addition, the dimension inspection software installed in the control console 80 processes the 2-D stent map using proprietary algorithms, measures strut width, length, as well as other recipe-defined geometric features of the stent 30 at recipe-defined sampling points, outputs them to the results files.

Furthermore, the surface characterization software installed inside the control console 80 processes the raw data from the surface-scanning profiling subsystem 50, calculates strut's profile, thickness, surface roughness and other statistical values such as root mean square, peak-to-peak and mean value. This software also plots the 3-D graph of the surface topography of the stent 30, outputs them to the results files.

All the raw images, stitched 2-D stent map, 3-D stent topography graph and results files are send to the database server, ready for users to access, either remotely via network or onsite.

After completion of all the steps described above, the operator starts another inspection cycle by repeating Step 1 through Step 4.

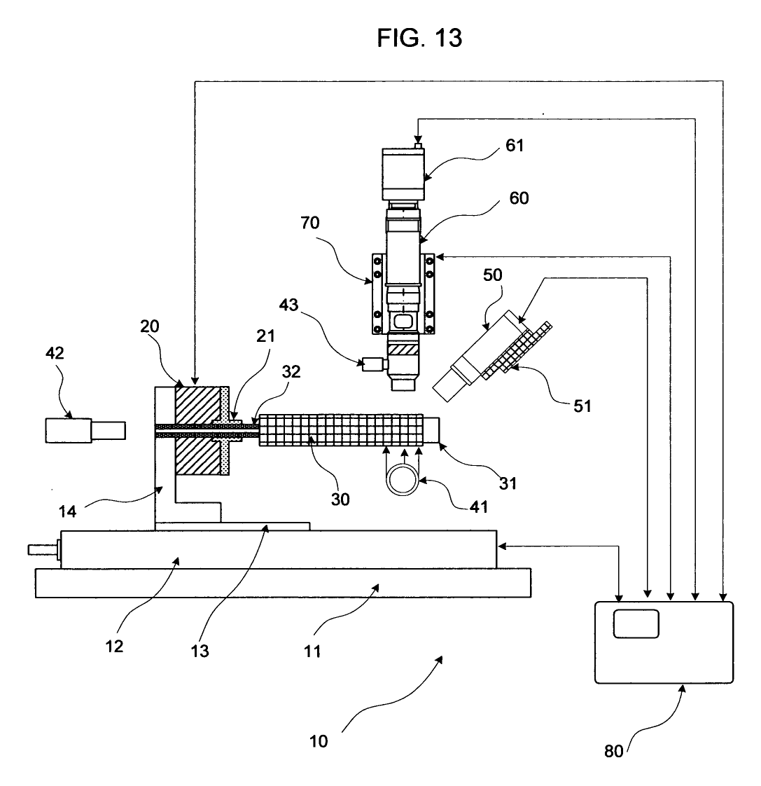

Now referring to FIGS. 5 and 13, in the second embodiment of the present disclosure, the system 10 is used to inspect a stent with relatively large geometric dimensions. In this case, the magnification of the zoom lens 63 can be set to the lower end, increasing both the field of view and the depth of the field of the of optical imaging subsystem 60. As a result, the depth of field becomes large enough to compensate variations of the vertical position of the stent 30 due to stage motion and dimensional derivations. It becomes unnecessary to actively control the movement of the vertical stage 70 to keep the working distance of the optical imaging subsystem 60 constant, as described in the above embodiment. In other words, the auto-focusing function performed by the vertical stage 70 can be turned off. Instead, the vertical stage 70 can be set to the pre-determined position and keep unchanged during the inspection cycle: Steps 1 through 4 described above. By doing so, the time spent on auto-focus adjustment by the vertical stage 70 is eliminated. Plus, the increased field of view leads to fewer images to be taken by the color camera 61. The combined impact of increased field of view and depth of focus is the notable reduction of inspection time and thus notable improvement of throughput.

The operation of this second embodiment of the system 10 is substantially the same as Steps 1 through 4 described above, except that the position of the vertical stage 70 is pre-set and kept unchanged during the inspection process.

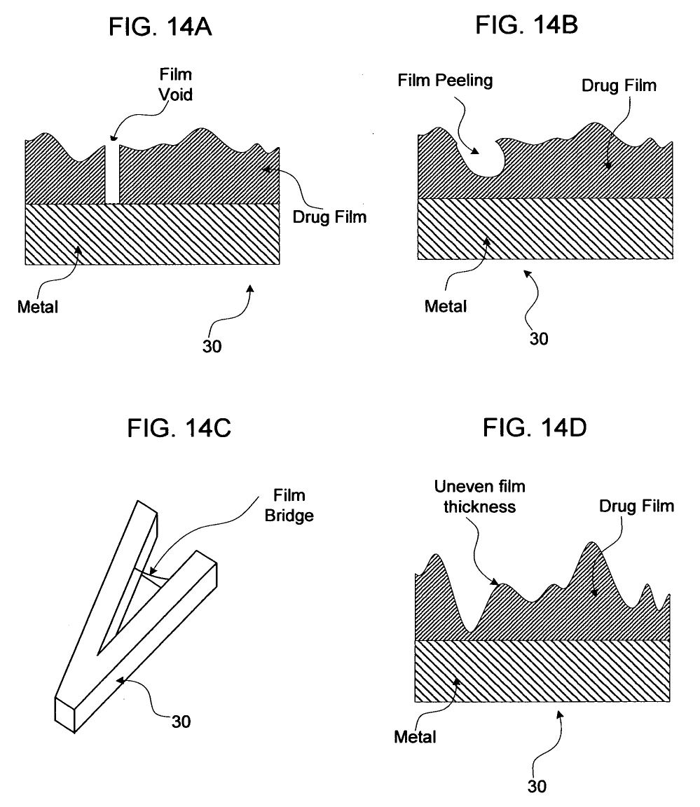

Now referring to FIG. 1 and FIGS. 14A-D, in the third embodiment of the present disclosure, the system 10 is used to inspect a drug eluting stent, or DES. A drug eluting stent consists of a metallic stent covered with drug-containing film to prolong drug release. In this case, the defects to be detected are film related, such as voids, flakes, and bridges across struts shown in FIGS. 14A-C. To achieve best detection performance, referring to FIG. 5, a proper type of filter 67 of the optical imaging subsystem 60 is utilized for each specific drug films. The types of the filter 67 include, but not limited to, red, green, blue, bandpass, short-pass, long-pass, UV and IR filters, as well as polarizers. Also the defect detection and classification software installed in the control console 80 uses image processing algorithms different from those used in a bare metal stent inspection.

Furthermore, the surface-scan profiling subsystem 50 is used to measure surface roughness, thickness and coating uniformity of the drug films, as shown in FIG. 14D.

The operation of this third embodiment of the system 10 is substantially the same as Steps 1 through 4 described above.

What is claimed is:

1. An automatic stent inspection system consists of:
an optical imaging subsystem to image a portion of a stent;
a surface-scanning profiling subsystem to measure the profile and surface roughness of a stent;
a telecentric illuminator to provide telecentric illumination to facilitate precise dimension measurement of a stent;
an external illuminator to provide uniform illumination to the interior surface of a stent;
a co-axial illuminator to provide uniform illumination to the exterior surface of a stent;
a linear stage to move a stent from its load position to the inspection position and feed successively different stent segments to the inspection position in a step-and-stop fashion;
a rotary stage to rotate a stent along the circumference direction in a step-and-stop fashion;
a vertical stage to adjust the distance between the optical imaging subsystem and the stent surface;
a positioning assembly to adjust the distance between the surface-scanning profiling subsystem and the stent surface under measurement;
a mandrel on which the stent in mounted;
a mandrel holder to hold the mandrel;
a collet chuck to hold the mandrel holder; and
a control console to provide tool control functions as well as at least the following capabilities: 1) automatic defect detection and classification, 2) automatic dimension inspection; 3) automatic surface roughness and profile measurement, 4) automatic report of inspection and measurement results, and 5) data and image database management.

2. The system of claim 1, wherein the optical imaging subsystem further comprises:
a co-axial illumination input port;
an optical filter which allows the passage of predetermined wavelengths;
an objective lens or a lens assembly;
and half-mirror;
a focusing lens;
a zoom lens assembly;
a magnifier lens; and
a high resolution area scan color camera.

3. The system of claim 1, wherein the surface-scanning subsystem is a high resolution surface scanning laser confocal displacement measuring system.

4. The optical imaging subsystem of claim 2, wherein the filter 67 is a polarizer.

5. The optical imaging subsystem of claim 2, wherein the focusing lens is a motorized lens.

6. The optical imaging subsystem of claim 2, wherein the focusing lens is an auto-focus lens.

7. The system of claim 1, wherein the telecentric illuminator comprises:
a light source;
a spatial filter;
a telecentric lens assembly; and
a fold mirror.

8. The system of claim 1, wherein the external illuminator comprises:
a light source;
a diffuser; and
a focus lens.

9. The system of claim 1, wherein the co-axial illuminator comprises:
a light source;
a diffuser; and
a collimate lens.

10. The telecentric illuminator of claim 5, the external illuminator of claim 6, and the co-axial illuminator of claim 7, wherein the light source is a fiber optics coupled to an independent remotely located lamp.

11. The fiber optics of the claim 8, wherein the density of the lamp is controllable.

12. The telecentric illuminator of claim 5, the external illuminator of claim 6, and the co-axial illuminator of claim 7, wherein the light source is an array of LEDs.

13. The array of LEDs of the claim 10, wherein the density of each LED is independently controllable.

14. The system of claim 1, wherein the vertical stage automatically adjusts the distance between the optical imaging subsystem and the stent surface using auto-focusing mechanism, bring the optical imaging subsystem to the best focus position.

15. The system of claim 1, wherein the vertical stage adjusts the distance between the optical imaging subsystem and the stent surface based on the motion profile stored inside the control console, bring the optical imaging subsystem to the best focus position.

16. The system of claim 1, wherein the positioning assembly automatically adjusts the distance between the surface-scanning profiling subsystem and the stent surface according to the user-defined recipes.

17. The system of claim 1, wherein the distance between the surface-scanning profiling subsystem and the stent surface is manually adjusted by an operator before inspection.

18. The system of claim 1, wherein a mandrel is a tube or rod made of sapphire.

19. The system of claim 1, wherein the mandrel is a tube or rod made of quartz.

20. The system of claim 1, wherein the exterior surface of the mandrel is unpolished.

21. The system of claim 1, wherein the exterior surface of the mandrel is polished.

22. The system of claim 1, wherein the control console displays acquired images from the color area scan camera, and profile as well as surface roughness data from the surface-scanning profiling system, controls the motion of the linear, rotary and vertical stages, controls illuminators' on/off timing as well as performs the following functions: 1) automatic defect detection and classification, 2) automatic dimension inspection; 3) automatic surface roughness and profile measurement, 4) automatic report of inspection and measurement results, and 5) data and image database management.

23. The system of claim 1, wherein the optical imaging subsystem captures images of a drug eluting stent. The defect detection and classification software installed inside the control consol detects defects related to the drug films covering the metallic surface using image processing algorithms different from those used to inspect metallic surfaces.

24. The system of claim 1, wherein the surface-scanning profiling subsystem scans the film surface of a drug eluting stent. The surface characterization software installed inside the control consol measures the film surface roughness and uniformity using signal processing algorithms different from those used to characterize metallic surfaces.

25. An stent inspection and view system consists of:
an optical imaging subsystem to image a portion of a stent;
a telecentric illuminator to provide telecentric illumination to facilitate precise dimension measurement of a stent;
an external illuminator to provide uniform illumination to the interior surface of a stent;
a co-axial illuminator to provide uniform illumination to the exterior surface of a stent;
a linear stage to move a stent from its load position to the inspection position and feed successively different stent segments to the inspection position in a step-and-stop fashion;
a rotary stage to rotate a stent along the circumference direction in a step-and-stop fashion;
a vertical stage to adjust the distance between the optical imaging subsystem and the stent surface;
a mandrel on which the stent in mounted;
a mandrel holder to hold the mandrel;
a collet chuck to hold the mandrel holder; and
a control console to provide tool control functions as well as at least the following capabilities: 1) automatic defect detection and classification, 2) automatic dimension inspection; 3) automatic report of inspection as well as measurement results, and 4) data and image database management.

26. An automatic stent surface characterization system consists of:
a surface-scanning profiling subsystem to measure the profile and surface roughness of a stent;
a linear stage to move a stent from its load position to the inspection position and feed successively different stent segments to the inspection position in a step-and-stop fashion;
a rotary stage to rotate a stent along the circumference at constant speed;
a positioning assembly to adjust the distance between the surface-scanning profiling subsystem and the stent surface under measurement;
a mandrel on which the stent in mounted;
a mandrel holder to hold the mandrel;
a collet chuck to hold the mandrel holder; and
a control console to provide tool control functions as well as the following capabilities: 1) automatic surface roughness and profile measurement, 2) automatic report of measurement results, and 3) data database management.
